(19) United States
(12) Patent Application Publication
(10) Pub. No.: US 2024/0144293 A1
(43) Pub. Date: May 2, 2024

(54) MACHINE LEARNING-BASED PHARMACEUTICAL REGULATORY COMPLIANCE INFORMATION SYSTEM AND METHOD

(71) Applicant: Pharma Solutions USA, Inc., Penn Valley, PA (US)

(72) Inventors: Rick BRADDY, Cypress, TX (US); Adam MARANO, Dadeville, AL (US); Sumeet SINGH, Mesa, AZ (US)

(73) Assignee: Pharma Solutions USA, Inc., Penn Valley, PA (US)

(21) Appl. No.: 18/206,494

(22) Filed: Jun. 6, 2023

Related U.S. Application Data
(60) Provisional application No. 63/381,634, filed on Oct. 31, 2022.

(51) Int. Cl. G06Q 30/018

(52) U.S. Cl. CPC G06Q 30/018

(57) ABSTRACT

In one aspect, a method is disclosed for determining regulatory requirements for a facility, is disclosed. The method includes transmitting a plurality of requests for display on a user device, the plurality of requests prompting the user for facility information. The method includes receiving a selection in a first screen of a user interface of the user device, the selection including at least one jurisdiction of the user. The method includes generating a second screen for display on the user device, the second screen including a request for additional requirements, the request based on a jurisdiction received in the selection. The method includes receiving a second selection in the second screen displayed on the user device, the second selection including an identification of a product selected by the user. The method includes storing the first and second selection in a memory for transmission to an analytics device.

### CROSS-REFERENCE TO RELATED APPLICATIONS

This application claims the benefit of U.S. Provisional No. 63/381,634 filed Oct. 31, 2022, the entire contents of which are hereby incorporated by reference. The entire disclosure of each of the above items is hereby made part of this specification as if set forth fully herein and incorporated by reference for all purposes for all that it contains.

Any and all applications for which a foreign or domestic priority claim is identified in the Application Data Sheet as filed with the present application are hereby incorporated by reference under 37 CFR 1.57.

### FIELD OF THE INVENTION

The present invention relates to information systems and methods for facilitating compliance with the regulatory requirements of individual states and other jurisdictions, and specifically with facilitating such compliance by pharmaceutical supply chain companies.

### DESCRIPTION OF THE RELATED TECHNOLOGY

A modern economy includes numerous regulations to increase public safety, business transparency, and competitive fairness. Regulatory initiatives with any of these disparate goals, or other objectives, tend to advance in a piecemeal manner among the various Governmental jurisdictions having oversight in a modern economy. Some jurisdictions may have the same requirements or the same effective requirements, but in many cases, there are both similar and different requirements between two jurisdictions. This occurs in the United States in which commerce is regulated by the Federal government as well as individual states and occurs in other regions such as the European Union which are governed simultaneously by autonomous national governments and by the multinational European Union.

Businesses seeking geographic diversity as well as expansion frequently must implement business models that comply with multiple overlapping sets of jurisdictional requirements, and thus are challenged by the variety and mismatch of those requirements.

This challenge is acute in the business of pharmaceutical distribution. Regulated drug manufacturers, distributors, virtual distributors, and pharmacies have numerous requirements in each jurisdiction, designed to ensure the proper distribution of regulated pharmaceuticals, as well as compliance with applicable licensing requirements for pharmaceuticals.

To date, the method for implementing compliance with overlapping has primarily been to enlist professionals and law firms with specialized expertise in the regulatory framework in each jurisdiction where business is to be conducted, and to have those professionals guide the process of regulatory compliance both for initial business licensing and continuing license maintenance. While this method has been used by many organizations with a measure of success, there remains a need to improve the process of regulatory compliance, and to streamline the process of gathering or researching information about a business to determine the regulatory requirements that the business must meet for its current jurisdictions and business operations.

### BRIEF DESCRIPTION OF THE DRAWINGS

In order to describe the manner in which the above-recited and other advantages and features of the disclosure can be obtained, a more specific description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example routine for initiating the selection of requirements according to some aspects of the disclosure.

FIG. 1B illustrates the use of selected jurisdictions and activities to build an applicable data set of selectors, in accordance with aspects of the disclosure.

FIG. 1C illustrates the process of producing views or outputs of research results obtained by the preceding operations, in accordance with aspects of the disclosure.

FIG. 2 illustrates a sample architecture of processing user selections to generate a plurality of results, in accordance with aspects of the disclosure.

FIG. 3A illustrates the architecture and formats used for administration and operation of the research administrator, in accordance with aspects of the disclosure.

FIG. 3B illustrates processes of the data change activation component of the architecture in accordance with some aspects of the disclosure.

FIG. 3C illustrates the user compliance answer configuration component of the research administrator in accordance with some aspects of the disclosure.

FIG. 3D illustrates the analytics engine component of the architecture, in accordance with aspects of the disclosure.

FIG. 3E illustrates the results engine component of the research administrator, in accordance with aspects of the disclosure.

FIG. 3F illustrates a change monitoring component of the architecture, in accordance with aspects of the disclosure.

FIG. 4 illustrates an example neural network architecture, according to one aspect of the present disclosure.

These accompanying drawings, which are incorporated in and constitute a part of this specification, illustrate embodiments of the invention and, together with a general description of the invention given above, and the detailed description of the embodiments given below, serve to explain the principles of the invention.

### DETAILED DESCRIPTION OF THE INVENTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Glossary of Terms of the Technology

The following definitions are applicable to the terminology used herein in description of the present invention:

Selector—a text string associated with a Requirement specifying a logical expression that, if true, indicates the associated Requirement has been selected or is “in play” and applicable.

Requirement—an item of data in the Requirements database table representing a unique requirement or license.

Logical expression—a statement that can either be True or False.

Logical expression evaluation—the action that determines whether a logical expression is True or False.

QMAP—a technical term describing the “Selector” concept: a Selector maps a set of Questions to a Requirement.

Question/Answer (Q/A)—a database record, which represents a set of questions and answers obtained from the Research about a business, how and where it does business. This set of questions and answers inquires as to business attributes related to a business for which Research Activities are being conducted.

Research Questionnaire: A set of questions that ALTAS Research will ask the user related to the type of research they want to perform.

Q/A Label—a text label representing a Question, e.g., FO1.1

### Jurisdictional Terms

Doing Business In (DBI): This is the list of jurisdictions (e.g., 50 US States+Washington DC+Puerto Rico) that the user selects that they do business in when setting up a research job.

Ends Up In (EUI)—A list of “extra” jurisdictions that the user can opt to check that may have special requirements matches even if the user does not select one of the jurisdictions included in the EUI list in their DBI selections. This helps a user find requirements that they otherwise may not know they needed in possible jurisdictions that product or business activity may end up in. The EUI can check to ensure that a product is being shipped into a state or jurisdiction by a third party. The state can subsequently be included in the list of jurisdictions for consideration.

Resident State: This is the jurisdiction that the facility is physically located in (in almost all cases). Having this value is important being some jurisdictions will (usually do) require that the facility have a license for their Resident State. This requirement typically exists even if the facility is NOT doing business in their Resident State. Normally, in the businesses' Resident State, it requires some license.

Now turning to a detailed description of the selection of Requirements according to the principles of the present invention, a Research Activity module organizes Requirements into a table of DynamoDB items. One item attribute for each Requirement is its Selector. The Selector text string represents the business logic that determines when the Requirement is applicable.

### Overview

Disclosed are systems, apparatuses, methods, and computer-readable medium for determining regulatory requirements for a facility, is disclosed. The method includes transmitting a plurality of requests for display on a user device, the plurality of requests prompting the user for facility information. The method includes receiving a selection in a first screen of a user interface of the user device, including at least one jurisdiction of the user. The method includes generating a second screen for display on the user device, the second screen including a request for additional requirements, the request based on a jurisdiction received in the selection. The method includes receiving a second selection in the second screen displayed on the user device, the second selection including an identification of a product selected by the user. The method includes storing the first and second selections in a memory for transmission to an analytics device.

In an aspect, the method further includes generating a third screen for display on the user device, the second screen including a request for additional requirements, the request based on a jurisdiction received in the selection; and receiving a third selection in the second screen displayed on the user device, the second selection including an identification of a product selected by the user.

In an aspect, the analytics device is configured to perform: filtering the first and second selections at the analytics device, wherein the filtering comprises: defining a plurality of selectors associated with at least one requirement of the jurisdiction; and identifying a correlation between the first and second selection and the at least one requirement of the jurisdiction.

In an aspect, the selectors define one or more of activities, licenses, and regulatory requirements associated with the jurisdiction. the selectors define one or more of activities, licenses, and regulatory requirements associated with the jurisdiction.

In an aspect, the method further includes filtering the defined selectors to identify a minimum amount of queries of a memory related to the correlation between the first and second selection.

In an aspect, the method further includes determining additional selections are needed to identify a correlation; and automatically prompting the user via the user device with a plurality of additional requests for additional selections related to the jurisdiction selected.

In an aspect, the jurisdiction comprises one or more of a state, federal entity, or country associated with a plurality of regulations.

In another aspect, a system includes a storage (implemented in circuitry) configured to store instructions and a processor. The processor is configured to execute the instructions and cause the processor to: transmit a plurality of requests for display on a user device, the plurality of requests prompting the user for facility information, receive a selection in a first screen of a user interface of the user device, the selection including at least one jurisdiction of the user, generate a second screen for display on the user device, the second screen including a request for additional requirements, the request based on a jurisdiction received in the selection, receive a second selection in the second screen displayed on the user device, the second selection including an identification of a product selected by the user, and store the first and second selection in a memory for transmission to an analytics device.

In another aspect, computer-readable medium comprising instructions using a computer system is disclosed. The computer includes a memory (e.g., implemented in circuitry) and a processor (or multiple processors) coupled to the memory. The processor (or processors) is configured to execute the computer-readable medium and cause the processor to: transmit a plurality of requests for display on a user device, the plurality of requests prompting the user for facility information, receive a selection in a first screen of a user interface of the user device, the selection including at least one jurisdiction of the user, generate a second screen for display on the user device, the second screen including a request for additional requirements, the request based on a jurisdiction received in the selection, receive a second selection in the second screen displayed on the user device, the second selection including an identification of a product selected by the user, and store the first and second selection in a memory for transmission to an analytics device.

In another aspect, a system includes a storage configured to store instructions is disclosed. The system also includes a processor configured to execute the instructions and cause the processor to determine a plurality of regulatory requirements for an entity includes at least one or more of a questionnaire, a plurality of requirements, a plurality of jurisdictions, and one or more filters configured to determine applicability of the plurality of regulatory requirements, the determining performed by steps includes identifying an answer to a plurality of questions in the questionnaire, receiving a selection of at least one jurisdiction in the plurality of jurisdictions, filtering the plurality of requirements based on a set of filter criteria to select one or more matching requirements, and storing the one or more matching requirements in a memory.

In another aspect, a system for determining regulatory requirements for a business is disclosed. The system includes a research activity processing module configured to perform the steps of defining a set of selectors for a regulatory structure, each selector in the set of selectors includes a data structure including a logical expression associated with a regulatory requirement, and a logical predicate indicating whether the regulatory requirement is applicable to a business, and gathering information on a business from a presentation of queries via a user interface that identifies a type of Business Activity in which the business is engaged, methods of manufacture, handling, or processing by a business of a product, and a type of business activity, where the business activity is based on the product ways in which product is made, handled or processed by the business, in one or more jurisdictions.

The following description is directed to certain implementations for the purposes of describing innovative aspects of various embodiments. However, a person having ordinary skill in the art will readily recognize that the teachings herein can be applied in a multitude of different ways. Examples are described herein in the context of systems and methods for adaptive transmit power control threshold recommendations. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

The present invention addresses this need by providing a regulatory compliance information system and method that determines the regulatory requirements for a business in a streamlined and automated manner. This inventive system and method include two functional modules, a Research Activity Module, and a Filtering module, that when coupled with multiple systems, and processors, can provide automation for determining the regulatory requirements of the business.

The first aspect is a Research Activity module which performs information gathering from a business principal for the purpose of determining a complete set of inputs to the filtering process. The purpose of the research module is to ask a set of questions that are necessary and sufficient to determine the type of business activity in which the business is engaged, specifically, the category of the business activity (e.g., wholesale/distribution, manufacturing, or retail), and the ways in which a regulated product is made, handled or processed by the business. Further, the Research Activity module identifies the jurisdictions relevant to the business and the types of business activity undertaken in those jurisdictions, to accurately characterize and identify the relevant regulatory frameworks to apply to the business. In the specific embodiment, the products are pharmaceuticals, but other products can be similarly subjected to regulation and handled by the system in other embodiments.

In the embodiment described below, the Research Activity module utilizes a data structure known as a Selector, which is a logical expression associated with a regulatory requirement and includes the logical predicate indicating whether that requirement is applicable to a business. Applicable requirements for a business are identified by querying the business principal to select applicable jurisdictions and business activities, which are then used to select the set of requirements that are applicable to those jurisdictions and business activities. Next, the substantive content of the selectors chosen based upon the jurisdictions and business activities, which may be presented to the operator and/or delivered to the Filter module.

The Filter module receives the selectors chosen by the Research Activity and filters the logical predicates of the selectors to identify a minimum necessary and sufficient set of queries relating to activities, licenses and other events or documents of regulatory interest necessary to resolve the logical predicate of each selector. This minimum necessary and sufficient set of queries may then be presented to the business principal and the responses used to resolve the logical predicate of each selector, and then provide the substance of those selectors logically resolved to true. This output thus defines the steps necessary to be taken to accomplish regulatory compliance in the chosen jurisdictions for the chosen business activities and related regulated products.

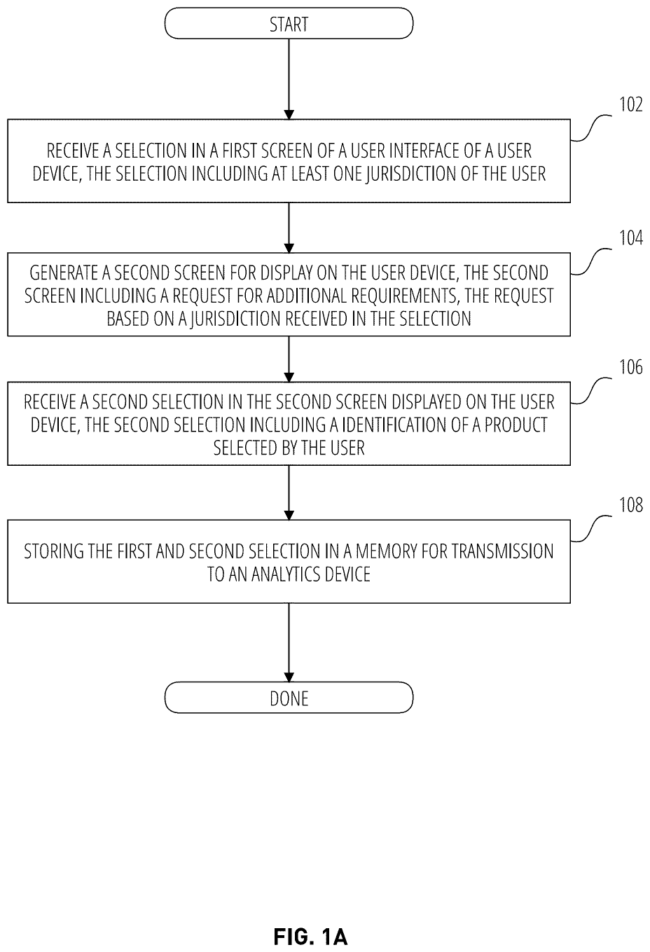

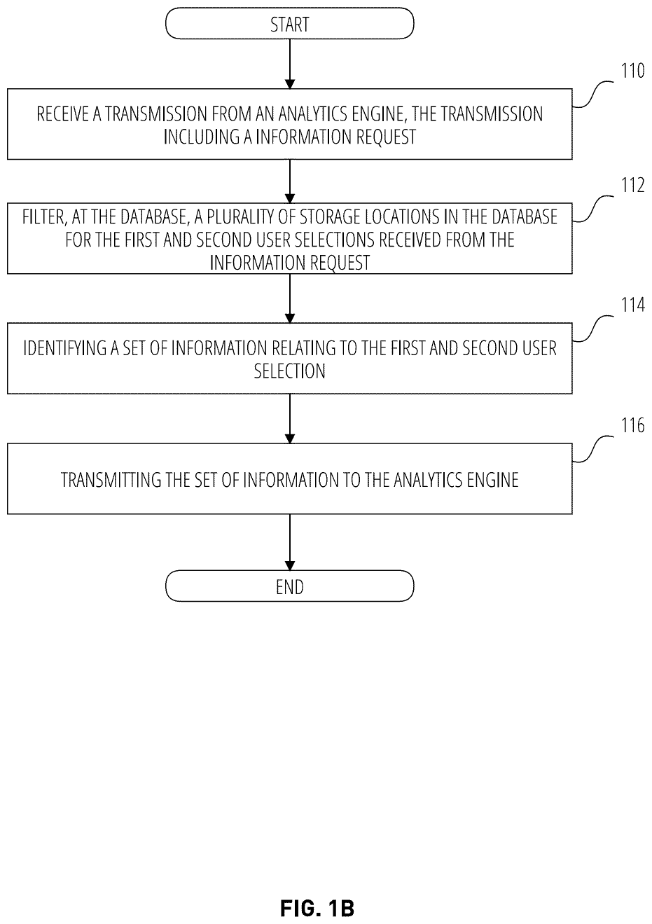

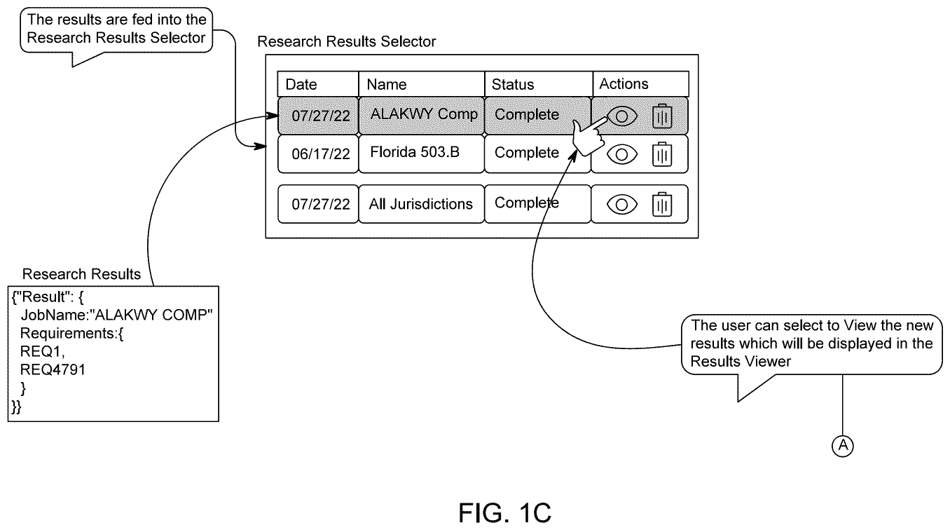

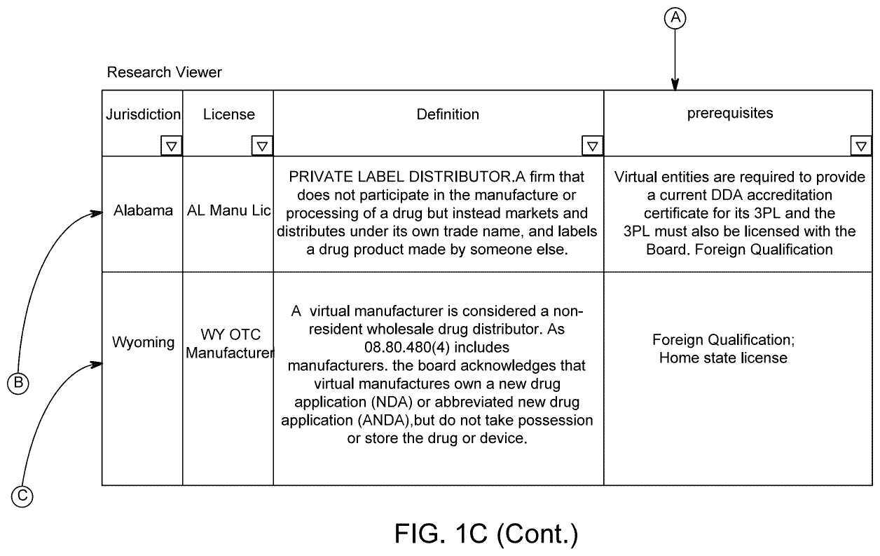

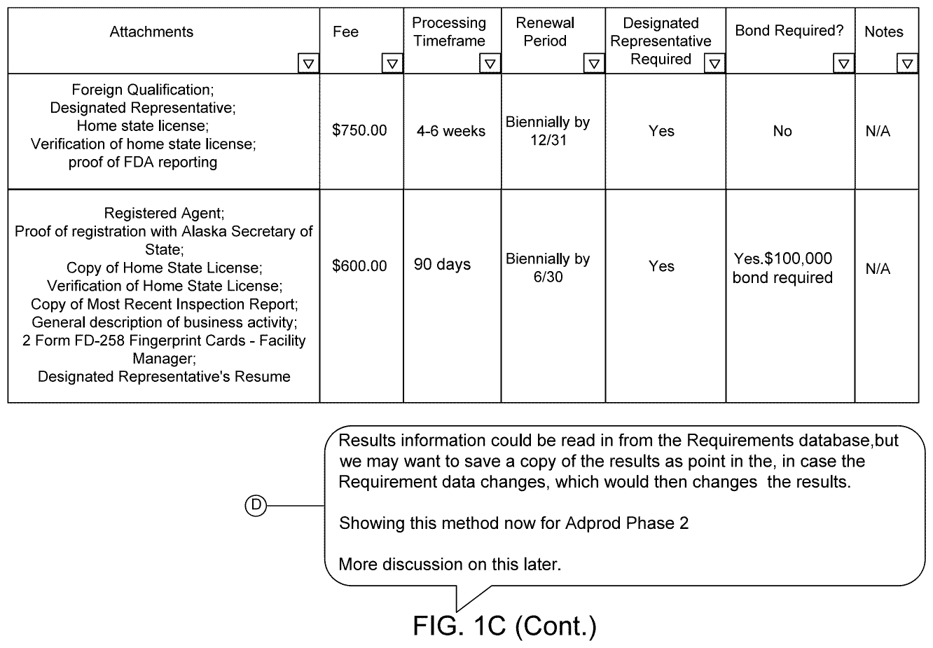

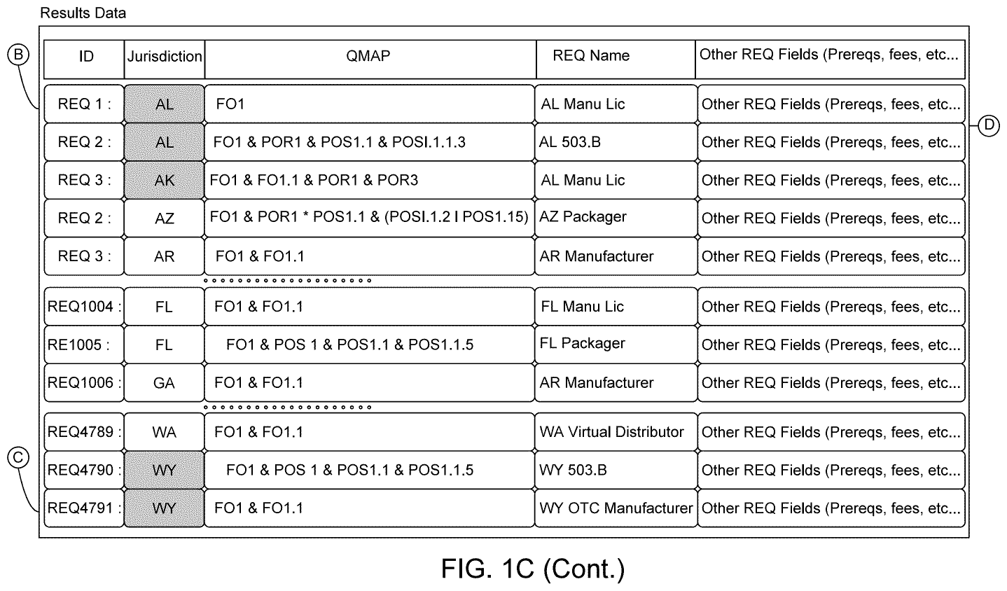

FIG. 1A illustrates an example routine for initiating the selection of requirements according to some aspects of the disclosure. Although the example routine depicts a sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. 1A illustrates the process of initiating the selection of Requirements, in accordance with some aspects of the disclosure.

The method can include the creation of a table in a database reflecting the jurisdictions and business activities identified by a business principal operating a user interface including a questionnaire of the system. Accordingly, the operator profiling a business for the process follows a questionnaire to identify the Research and chooses which jurisdictions are applicable, along with answering the relevant questions to generate the Question/Answer.

According to some examples, the method includes receiving a selection in a first screen of a user interface of a user device, the selection including at least one jurisdiction of the user at block 102. In an example, the controller can communicate with an analytics engine. The analytics engine can determine an interactive activity based on the user's interaction with the user interface on a user device. In some examples the interactive activity includes a selection of a jurisdiction type, a selection type, or a physical input, via the user device, of a relevant jurisdiction

The analytics engine checks whether the user selected to include EUI jurisdictions as part of the job. If so, any jurisdictions in the EUI list that the user did not select as a DBI when setting up the job, will be added to the list of jurisdictions to check requirements for. If there is a selection of NO during job setup to check EUI jurisdictions, the Research Activity only uses the Jurisdictions selected in the job setup and ignores the EUI list.

According to some examples, the method includes generating a second screen for display on the user device, the second screen including a request for additional requirements, and the request based on a jurisdiction received in the selection at block 104. In an example, the analytics engine queries a plurality of tables to determine which set of requirements stored in the plurality of tables, matches the applicable jurisdictions from the user's selections.

For example, the analytics engine can detect a Research Activity queries the Requirements data table to determine which requirements match the applicable Jurisdiction(s), using the jurisdictions contained in the Question/Answer+EUI jurisdictions if selected. This step results in a subset of requirement items being selected; for example, just those requirements applicable to California, Texas and New York, if those are the relevant jurisdictions.

According to some examples, the method includes receiving a second selection in the second screen displayed on the user device, the second selection includes an identification of a product selected by the user at block 106. In an example, the controller can receive a second selection from the user interface. The controller can prepare the second selection or transmission to the analytics engine. Where the analytics engine is configured to determine another set of requirements that matches the user selection.

For example, the Research Activity queries the Requirements data table to determine which requirements match the applicable Jurisdiction(s), using the jurisdictions contained in the Question/Answer+EUI jurisdictions if selected. This step results in a subset of requirement items being selected; for example, just those requirements applicable to California, Texas and New York, if those are the relevant jurisdictions.

According to some examples, the method includes storing the first and second selection in a memory for transmission to an analytics device at block 108. In an example, the analytics engine can transmit an analysis of the user's selection to a storage device. The analytics engine can prepare the user's selections into a JSON file, wherein the JSON file includes the user's selections, and the number of selections made. The memory can receive the JSON file to be stored in one or more files of the memory.

For example, the Research Activity evaluates each Requirement to determine if it is relevant and applicable, based on the relevant answers contained in the Question/Answer File. The end result is a list of requirements that would appear in an assessment based on the answers to the question. Each of the Requirements chosen in Part C (that matched a Jurisdiction), has an associated Selector, used in the following steps.

FIG. 1B illustrates the use of selected jurisdictions and activities to build an applicable data set of selectors, in accordance with aspects of the disclosure. Referring to FIG. 1B, the identified jurisdictions and activities are used to build a data set of selectors. As each selector string specifies the criteria that must be met for the associated requirement to be selected or chosen, the selectors can be winnowed to a smaller set based upon the selected jurisdictions and activities identified in the preceding steps.

As noted above, selectors evaluate to a positive or negative result from the selected jurisdictions and activities to determine applicability in the request received from the analytics engine by the memory. In an example, if a requirement selector included in a plurality of selectors of the request for additional requirements is true, then the requirement is applicable. Otherwise, the requirement selector is considered false and not required for compliance. In an example, the selectors can be structured and evaluated as a python logical expression. The logical express can be considered a valid python logical expression. The logical expression can further a have a Q/A label, input as a string, representing a question/answer pair.

In an example, jurisdictional and activity information can be used to create a subset of selectors, in the form of a QMAP list that is substantially smaller than the original set of selectors. For example, 5,000 selectors can be defined to identify the regulatory requirements of all jurisdictions. However, a set of only 300 selectors may be generated after applying jurisdictional and activity information to the selectors. The resulting set of selectors in the data set can be delivered as a results set to be presented for articulation in a plain language format, via a user interface presented to a user via a user device. The user may then select and interact with this data set via the user interface.

FIG. 1C illustrates the process of producing views or outputs of research results obtained by the preceding operations, in accordance with aspects of the disclosure. In order for the user device to receive a presented user interface 118 of the data set on the user device, the controller of the user device must collect the data set of results 120 from the controller, and the corresponding data set information 122 of the data set from the database. The user interface 118 allows the user via a user device to collect all the data in a viewable format via a display of the user interface. The user can interact with the result in the user interface 118. A controller of the user device can detect the user interaction selected a profile received from the data set of results 120, in a first presentation. The controller of the user device can receive the user interaction and determine that the user has selected a profile associated with a set of results stored in a storage device. The controller of the user device can request profile including the corresponding set of results. Upon retrieving the profile from the database, a second presentation can be presented to the user via the user interface 118, allowing the user to continue further user interactions. The user interactions can include, filtering, selecting one or more categories of the set of results, and selecting a new profile to review.

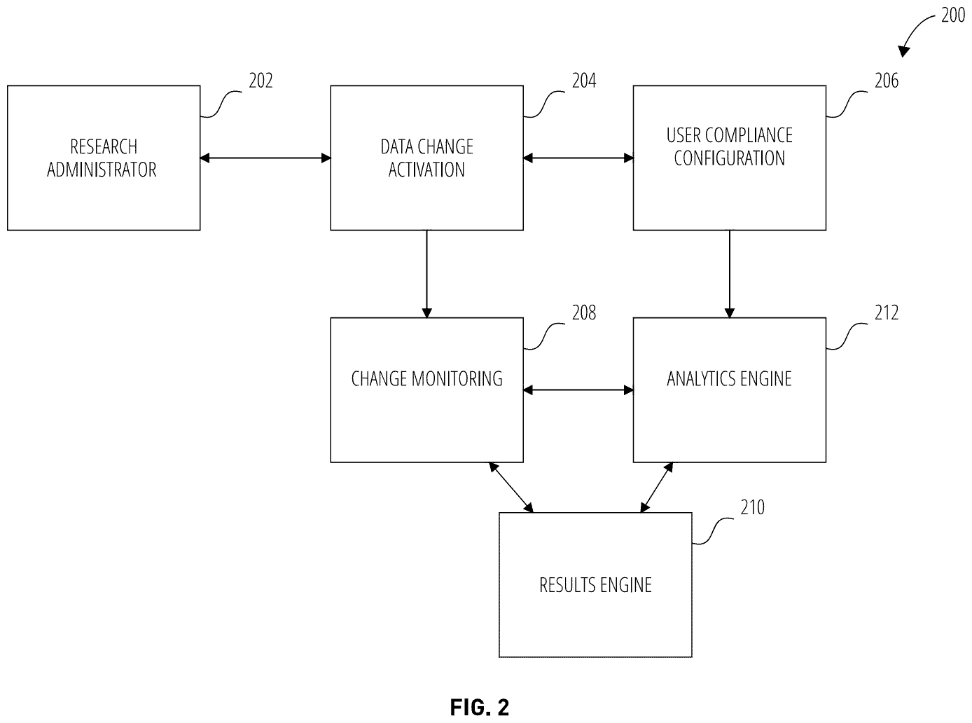

FIG. 2 illustrates a sample architecture 200 of processing user selections to generate a plurality of results, in accordance with aspects of the disclosure. FIG. 2 includes a plurality of computing engines configured to perform a plurality of instructions from a controller of each device. The computing device can include one or more or research administrator 202, data change activation 204, user compliance configuration 206, a change monitoring 208, an analytics engine 212, and a results engine 210.

The research administrator 202 is configured to receive a plurality of user selections from a user device The user selections collects data from the user device pertaining to a relevant jurisdiction and plurality of requests related to the relevant jurisdiction. The research administrator 202 can be configured to operate a standalone system operating on a computing device, or be integrated into a single device connected to a network environment.

The data change activation 204 is configured to activate data which makes it live in a production database. The data change activation 204 can approve data change in a question and answer (Q/A) data set and selected which data changes should be pushed to the other computing engines in the architecture 200.

The user compliance configuration 206 provides a user a user interface via their user device that allows the user to create the answers needed by the analytics engine 212 to perform an analysis of the user selections and produce a plurality of correlations or results. The user compliance configuration 206 also provides other general management capabilities like the ability to delete previous versions of user selections.

The change monitoring 208 is used to identify what changes made in the research administrator 202 and activated to live data in the data change activation 204. The data that is activated may impact a user's previous results so that it can notify the customer that associated changes exist that they should review, request the analytics engine 212 to repeat the analysis associated with the impacted results for the user so they automatically have a new set of results that can compare to the results prior to the changes, to remedies associated with historical data of impacted results.

The analytics engine 212 is configured to use user-created selections and answers to find matching requirements from the live data in a storage device to generate results for the analytics engine 212 to process.

The results engine 210 is configured to allow the user to view and manage the results via the user interface of the user device. The results are generated by the analytics engine 212 and transmitted to the results engine to process and prepare in a plurality of different presentations and screens, displayable, and in some instances scaled to be presented on the user device.

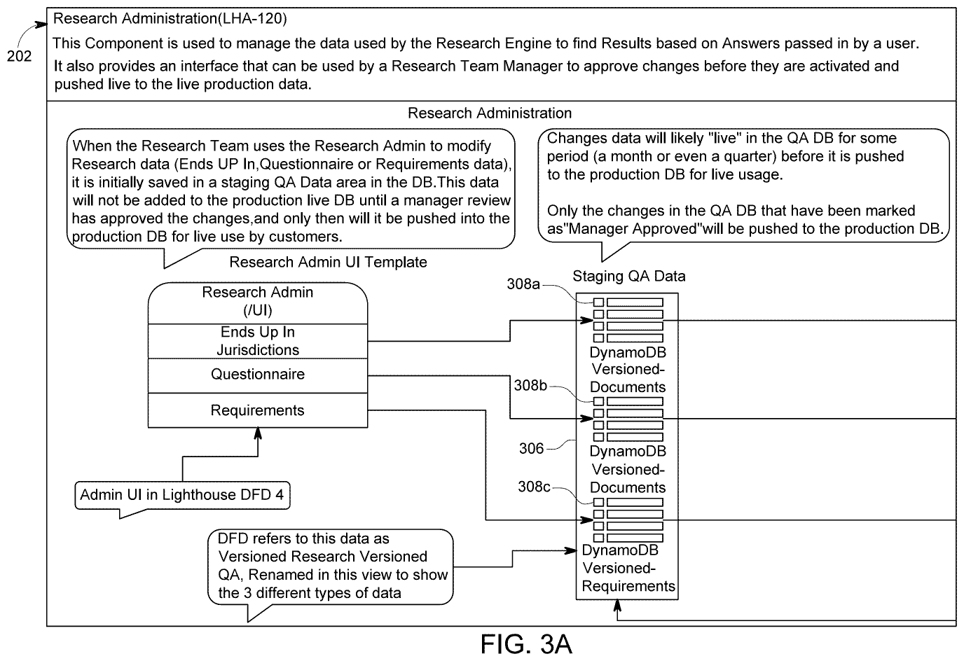

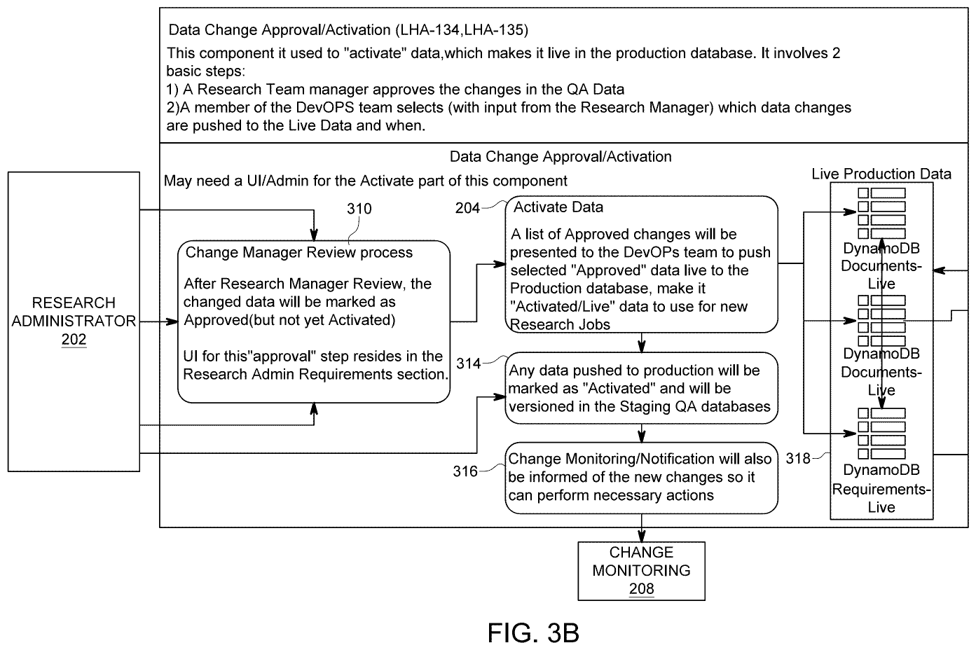

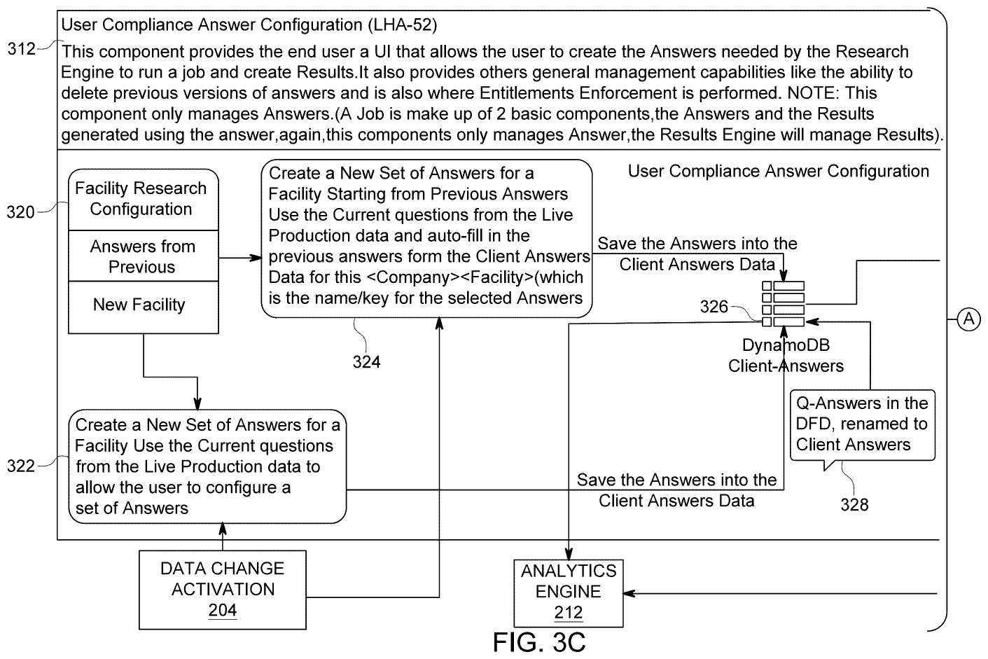

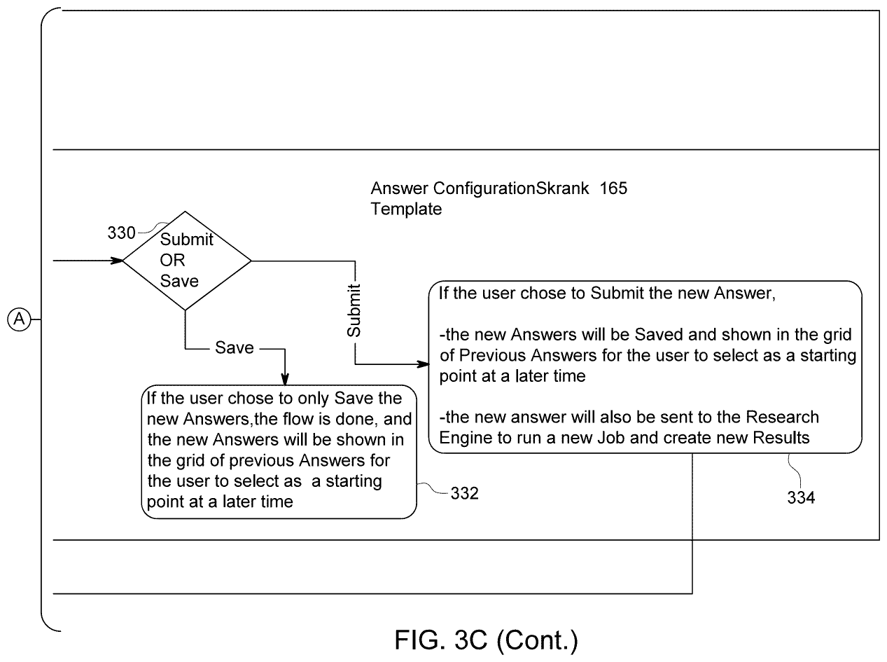

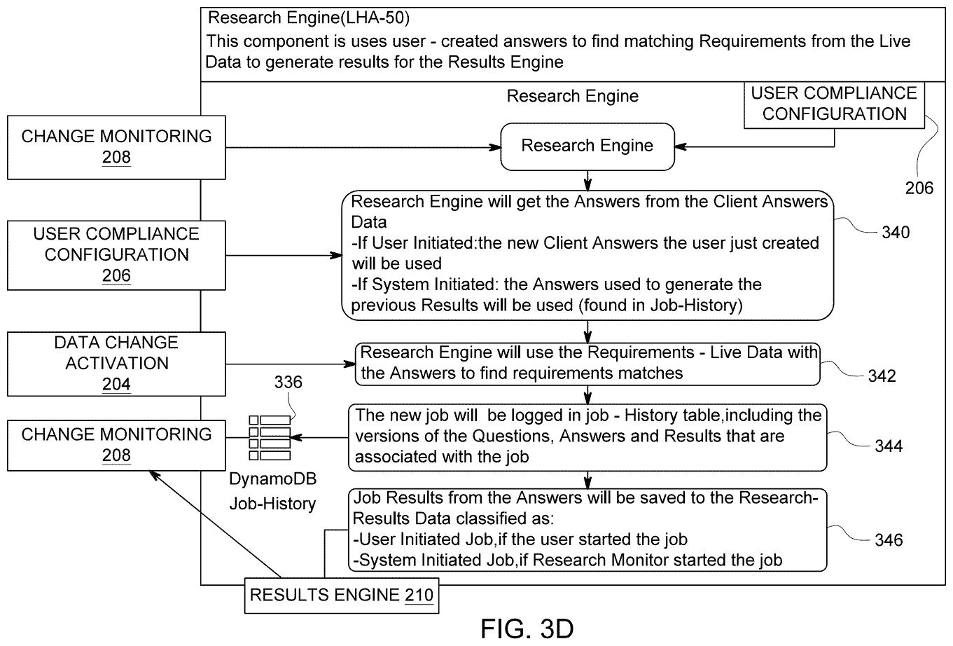

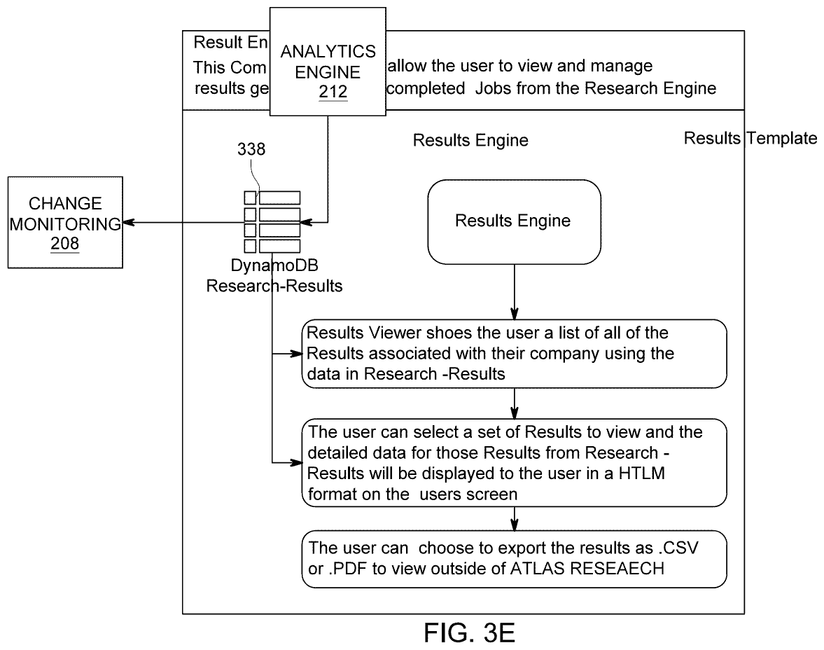

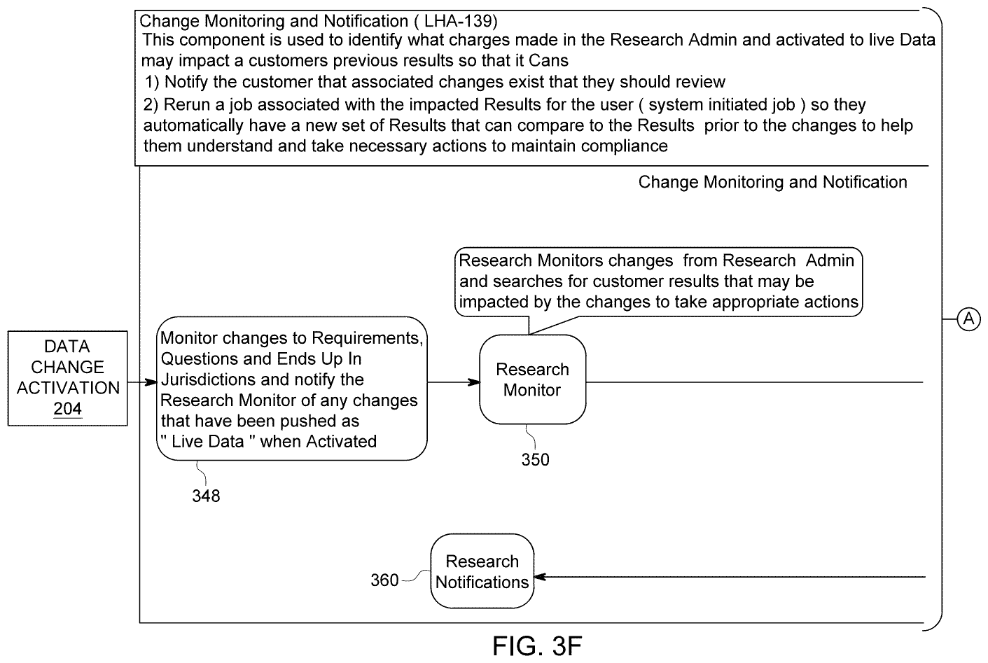

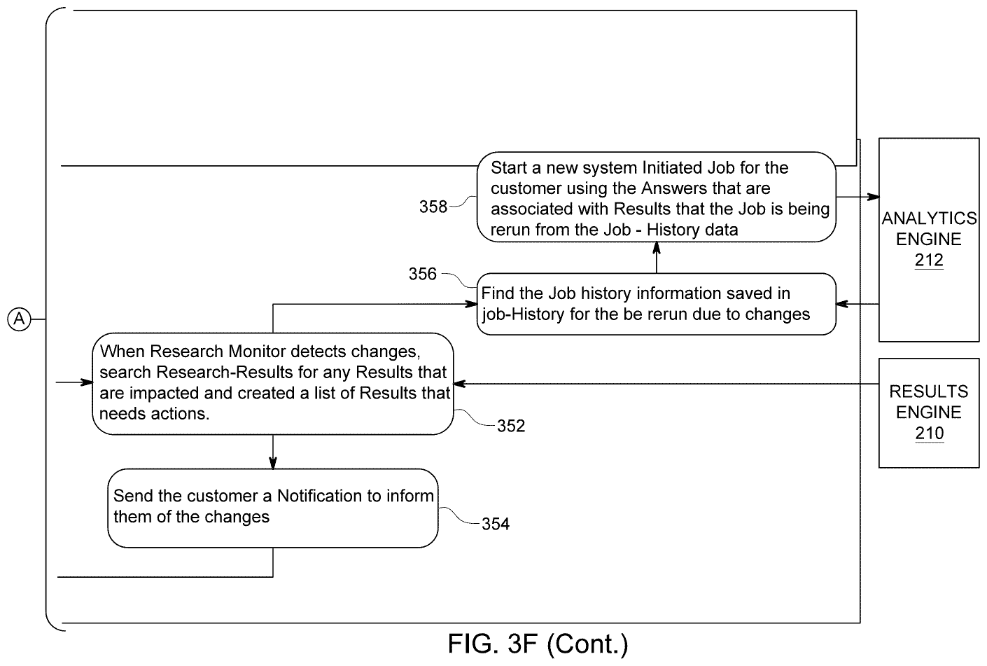

The following descriptions in FIG. 3A-FIG. 3F describe the communications between each of the elements of the architecture 200. Each of the research administrator 202, the change monitoring 208, the change monitoring 208, the analytics engine 212, and the results engine 210 each have a controller embedded within their associated computing devices. In some instances, each of the elements 202-212 of the architecture 200 can share a standalone controller configured to communicate with each element 202-212.

FIG. 3A illustrates the architecture and formats used for the administration and operation of the research administrator 202, in accordance with aspects of the disclosure. FIG. 3A illustrates the architecture, administration, and operation of the research administrator 202 in FIG. 2, in accordance with the previously discussed embodiments, which produces and manages research data that will be used by the analytics engine 212 to find results based on selections provided by a user to requests by the research administrator 202. The research administrator 202, is communicated to a user device via an admin user interface 304 that provides a plurality of admin requests 302. The admin requests 302 can include one or more of EUI jurisdictions, a plurality of sub-requests in the form of questions, or a request for jurisdictional requirements. Once the responses to the admin requests 302 have been completed, they are transmitted to the admin controller 306. The admin controller 306 begins to stage the QA data. The staging process takes the form of processing components which form and exchange DynamoDB objects in order to manage regulatory research data and business information and produce Results in the form of requirements for the business, and implement change management to update those requirements in view of changes to the research data.

In some examples, the admin requests 302 can include a plurality of selectors that can be initially defined by a comma-separated version (CSV) of an input file, known as a research database. The admin user interface 304 can receive data entry intended to create and provide maintenance of the research database. This database, represented by a plurality of memory 308a-308c, in the admin controller 306, contains all the current research data on compliance across the supported states and jurisdictions. The actual database tables are housed within a remote server-less relational database platform.

In an example, updates to the research database are implemented by an ongoing process of regulatory monitoring, to identify significant regulatory changes and reflect those changes within the research database. These changes can be audited during the transition of the research database from Development to Staging, to verify appropriate new compliance requirements or changes to existing requirements are occurring.

In an example, within the change monitoring 208 in FIG. 2, changes made in the research data are monitored and evaluated in comparison to previous results, to determine instances in which results may be changed by the new research data. This can be determined in order to trigger the other components of FIG. 3A to use previously gathered answers to create a new set of Results for a customer to help the customer identify any action steps necessary as a result of the changes in the research data. Changed research data is evaluated in a Data Change Approval/Activation component, shown in FIG. 3B.

FIG. 3B illustrates processes of the data change activation 204 component of the architecture 200 in accordance with some aspects of the disclosure. This component implements a user interface for a plurality of users such a user team, or administrator team to evaluate changes to research data generated by the research administrator 202 and activated by the data change activation 204 for use by other components, or in a separate environment such as a production environment.

In step 302, a change management review process can be initiated. The change management review process 310 can monitor for research administrator 202 approval being received from the user interface.

In step 303, once the data has been approved, the data associated with the approval is activated and prepare for publishing in a live environment or a separate environment associated with the architecture 200 in FIG. 2.

In step 318, the published data, and a historical record of all approved and activated data can be pushed to the separate environment and subsequently stored in a memory of the data change activation controller 318 configured to publish the data.

The data that is published can further be marked as activated. A notification of the data being marked as activated can be transmitted to the plurality of memory 308a-308c of the admin controller 306.

FIG. 3C illustrates the user compliance answer configuration component of the research administrator 202 in accordance with some aspects of the disclosure. The research administrator 202 generates the user interface through which a user provides answers, through a series of selections, in response to admin requests, effectively creates a data set of results. The change monitoring 312 provides the end user, through the user interface, the ability to create the selections to the admin requests 302, to provide the analytics engine 212 data to prepare an analysis. The change monitoring 312 can further provide general management capabilities, including the ability to delete previous versions of selections and perform entitlement enforcement of one or more selections received from the research administrator 202.

In some examples, the change monitoring 312 produces the user interface that allows a user to create selections in response to research data that is relevant to a facility/business, as explained previously herein. This component also combines previously provided selections with updates to the research data to identify additional selections required for a facility/business in light of changes implemented by the change monitoring 208 for example in the case of regulatory changes in one or more jurisdictions.

In the change monitoring 312, the facility research configuration 320 can process selections at the selection processor 322, the selections including selections from previous admin requests 302 in FIG. 3A, and facility information for a new facility applicable to the selections made by the user. A new set of selections can be transmitted for the new facility, where the change monitoring 312 processes the new set of selections with the latest set of admin requests 302 related to the facility. The new set of selections can be stored in a user compliance configuration memory 326. In some examples, the stored selections in the compliance configuration memory 326 can be renamed to new client selections.

The change monitoring 312 can transmit the selections from the previous admin requests 302 received from the change monitoring 208 to a previous selection processor 324. The previous selection processor 324 can use the current questions from the live production data and auto-fill in the previous selections from the subset of selection data. The results from the previous selection processor 324 can be transmitted to the compliance configuration memory 326.

At step 330, a controller of User Compliance Configuration 206 can determine whether to save or submit the data stored at the compliance configuration memory 326. If saving 332, the user can only save the new selections in the user interface. The new selections will then be displayed via the user interface of the user device, or available for selection by the user in real-time.

Alternatively, the change monitoring 312 206 can submit the data stored at the compliance configuration memory 326. If the user chooses to submit the new selections, the new selections can be stored in a database to be recalled being shown on the user interface. The new selections also can be transmitted to the analytics engine 212 for analysis.

FIG. 3D illustrates the analytics engine 212 component of the architecture 200, in accordance with aspects of the disclosure. The research administrator 202 uses answers from the user to find matching requirements from the research data. Answers provided by a user, or customer for a facility or business are processed by the analytics engine 212 component. This component uses the selections of the user to find matching requirements from the currently live research data and generates a database result set for the facility of the business, as well as a database job history reflecting the actions taken by the analytics engine 212 to allow later evaluation of changes in the Data Change Approval of Activation component (FIG. 3B) to obtain updated selections in the event of a later change in the research data.

At block 340, the analytics engine 212 can receive an instruction from the user compliance configuration to start a new analysis of the data received. The analytics engine 212 can also receive an instruction from the change monitoring 208 requesting for the new analysis to be initiated using the selections in the analysis history.

The analytics engine 212 can receive user selections from the change monitoring 208. If the user initiated a new user selection, the user of the profile will be used. If the system initiated the selection, the selections will be used to generate the previous results to be used. The analytics engine 212 can use the requirements for the live data from the data change activation 204 and correspond the live data with the user selections to find correlations between the live data and the user selections. The analytics engine 212 can log a new analysis in a table of analytics engine database 336. The new analysis at the analytics engine database 336 can include a plurality of versions of the user selections, admin requests 302, and the results thereof that are associated with the analysis. The results from the user selections can be stored to the analytics engine 212. The results from the user selections can be classified as a user-initiated analysis if the user performed the initiation of the analysis, or a system-initiated analysis if the research administrator 202 started the job.

FIG. 3E illustrates the results engine 210 component of the research administrator 202, which manages a user interface in which a user can view and manage results produced by the analytics engine 212. The results engine 210 can provide a user interface in which a user may view and manage results generated from the results engine 210 in the form of a database object, such as a DynamoDB object. The results of the analysis may also be exported in a variety of forms, such as a CSV or PDF formatted checklist or text document usable to implement the needed steps required for regulatory compliance.

The results engine 210 can show the user in a results viewer or display of the user device a list of all of the results associated with their company using the data stored in the results engine database 338. The user can then select a set of results to view, and the detailed data for those results from the analysis performed by the research will be displayed to the user in an HTML format on the user interface displayed on the display of the user device.

FIG. 3F illustrates a change monitoring 208 component of the architecture 200, in accordance with aspects of the disclosure. Job histories, analysis histories, and results produced by the analytics engine 212 are used by the change monitoring 208, seen in FIG. 3F. The change monitoring 208 evaluates changes in the research data activated by the data change activation 204 component and determines whether those changes impact results previously provided to a user. In the event of a change to research data impacts a facility/business, the change monitoring 208 component initiates a new analytics engine 212 analysis to evaluate the previously provided information for the facility or business with the new data from the analysis, to produce updated results for the user or customer to consider.

The change monitoring 208 can be configured to produce research and analysis notifications based on data collected from the data change activation 204, and the results engine 210. In block 348, the change monitoring 208 changes the requirements, the admin requests 302, and the EUI jurisdictions, and notifies the research monitor 350. The research monitor 350 monitors changes from the research administrator 202 and searches for customer results that may be impacted by the changes to take appropriate actions. In block 352, when the research monitor 350 detects changes, all results received from the results engine 210 are impacted. Thus, a new list of results can be generated indicating results that need action. In block 354, the change monitoring 208 can send the customer a notification, in the form of a research notification 360, to inform of the changes. In block 356, the change monitoring 208 can locate an analysis history of an analysis performed by the analytics engine 212. In block 358, a new system-initiated analysis for the user using the user's selections to the admin requests 302, are associated with the results the new analysis will re-analyze at the analytics engine 212.

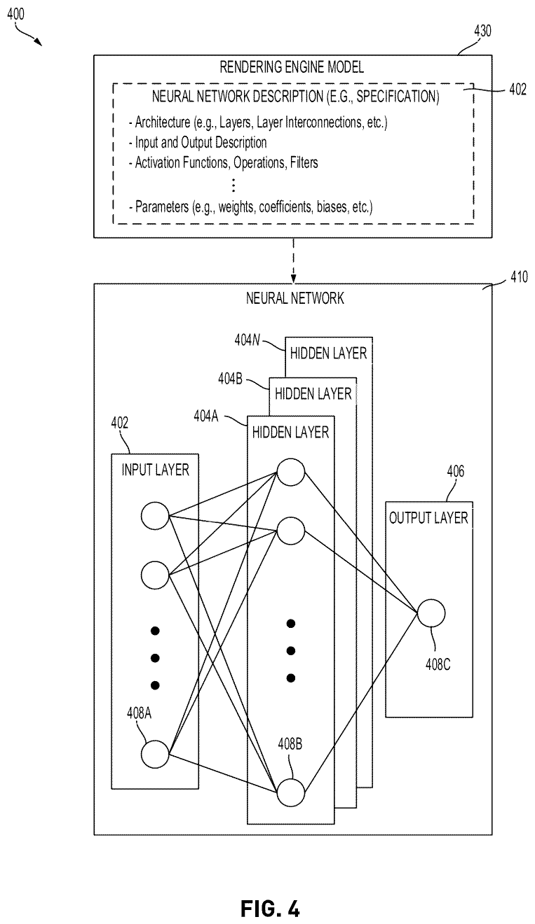

FIG. 4 illustrates an example neural network architecture, according to one aspect of the present disclosure. Architecture 400 includes a neural network 410 defined by an example neural network description 401 in the rendering engine model (neural controller) 430. The neural network 410 can represent a neural network implementation of a rendering engine for rendering media data. The neural network description 401 can include a full specification of the neural network 410, including the neural network architecture 400. For example, the neural network description 401 can include a description or specification of the architecture 400 of the neural network 410 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 410 reflects the architecture 400 defined in the neural network description 401. In this example, the neural network 410 includes an input layer 402, which includes input data, such as user responses to questions in the questionnaire related to the plurality of requirements. In one illustrative example, the input layer 402 can include data representing a portion of the answers from the user input data such as receiving a selection of at least one jurisdiction in the questionnaire from one or more user devices.

The neural network 410 include hidden layers 404A through 404N (collectively “404” hereinafter). The hidden layers 404 can include n number of hidden layers, where n is an integer greater than or equal to one. The number of hidden layers can include as many layers as needed for a desired processing outcome and/or rendering intent. The neural network 410 further includes an output layer 406 that provides an output (e.g., research notifications 360) resulting from the processing performed by the hidden layers 404. In one illustrative example, the output layer 406 can provide an identification of a user and/or labeling information of selected product(s) and service(s).

The neural network 410 in this example is a multi-layer neural network of interconnected nodes. Each node can represent a piece of information. Information associated with the nodes is shared among the different layers, and each layer retains information as information is processed. In some cases, the neural network 410 can include a feed-forward neural network, in which case there are no feedback connections where outputs of the neural network are fed back into itself. In other cases, the neural network 410 can include a recurrent neural network, which can have loops that allow information to be carried across nodes while reading in input.

Information can be exchanged between nodes through node-to-node interconnections between the various layers. Nodes of the input layer 402 can activate a set of nodes in the first hidden layer 404A. For example, as shown, each of the input nodes of the input layer 402 is connected to each of the nodes of the first hidden layer 404A. The nodes of the hidden layer 404A can transform the information of each input node by applying activation functions to the information. The information derived from the transformation can then be passed to and can activate the nodes of the next hidden layer (e.g., 404B), which can perform their own designated functions. Example functions include convolutional, up-sampling, data transformation, pooling, and/or other suitable functions. The output of the hidden layer (e.g., 404B) can then activate nodes of the next hidden layer (e.g., 404N), and so on. The output of the last hidden layer can activate one or more nodes of the output layer 406, at which point output is provided. In some cases, while nodes (e.g., nodes 408A, 408B, 408C) in the neural network 410 are shown as having multiple output lines, a node has a single output and all lines shown as being output from a node represent the same output value.

In some cases, each node or interconnection between nodes can have a weight that is a set of parameters derived from training the neural network 410. For example, an interconnection between nodes can represent information learned about the interconnected nodes. The interconnection can have a numeric weight that can be tuned (e.g., based on a training dataset), allowing the neural network 410 to be adaptive to inputs and learn as more data is processed.

The neural network 410 can be pre-trained to process the features from the data in the input layer 402 using the different hidden layers 404 in order to provide the output through the output layer 406. In an example in which the neural network 410 is used to identify user 102 and/or product(s) 108, the neural network 410 can be trained using training data that includes regulatory requirements of individual states and other jurisdictions (e.g., for initial business licensing and continuing license maintenance), and/or labeling and characteristic information (e.g., name, brand, size, manufacturer, handling instructions etc.) of product(s) and services offered by a business or entity. For instance, training images can be input into the neural network 410, which can be processed by the neural network 410 to generate outputs that can be used to tune one or more aspects of the neural network 410, such as weights, biases, etc.

In some cases, the neural network 410 can adjust the weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 410, the output can include values that do not give preference to any specific class due to the weights being randomly selected at initialization. For example, if the output is a vector with probabilities that the object includes different product(s) and/or different users, the probability value for each of the different products or services and/or users may be equal or at least very similar (e.g., for ten possible products or users, each class may have a probability value of 0.1). With the initial weights, the neural network 410 is unable to determine low-level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different from the predicted output. The goal of training is to minimize the loss so that the predicted output comports with a target or ideal output. The neural network 410 can perform a backward pass by determining which inputs (weights) most contributed to the loss of the neural network 410 and can adjust the weights so that the loss decreases and is eventually minimized.

A derivative of the loss with respect to the weights can be computed to determine the weights that contributed most to the loss of the neural network 410. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 410 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for down sampling), and fully connected layers. In other examples, the neural network 410 can represent any other neural or deep learning network, such as an autoencoder, deep belief nets (DBNs), recurrent neural networks (RNNs), etc.

The above components may be implemented in Python using Amazon Web Services (AWS) Lambda computing services; the identification of relevant Selectors, Research Results, and other components may be in the form of DynamoDB objects. In other embodiments, data may be stored in an SQL Server running on Windows Server with LighthouseAI, but preferably uses a serverless NoSQL database such as DynamoDB.

Each of the above components implements jobs to perform the described functions. New job requests are queued for scheduling and execution by adding an entry to the New Research Job Queue (an AWS SQS queue), which references the job specification dataset. When new SQS entries arrive, they trigger the Job Scheduler in the Job Engine, a set of AWS Step Functions, to initiate the new research job. The scheduler then launches one or more Research Jobs by triggering the appropriate AWS Lambda functions to execute.

Lambda functions execute logical queries to the NoSQL database (DynamoDB), apply the defined business rules, which produce Research Results Datasets, which are stored in DynamoDB.

Upon completion of a job, the Job Completion Queue receives a new queue entry, with references to the relevant database tables and other information required to produce the defined output. Jobs status is displayed via a new Job Status and Control page, where a list of running and completed jobs is shown. Administrative users may have various oversight capabilities, such as the ability to cancel jobs or restart them. If a job fails, this page will show an error message indicating why it failed, along with a link to view more detailed log files to debug/troubleshoot any issues.

Research Output Processors are triggered by SQS queue entries triggering AWS Step Functions that run the appropriate AWS Lambda functions which generate the desired reports or other output data that is to be delivered to the user. Finally, the Research Output Processors (written in Python) produce the PDF or other output data formats for the user. If email of reports or job completion notices are needed, AWS SES handles the outbound emails in a secure manner.

As referenced earlier, a Filtering process receives the output of the Research Module and analyzes the logical predicates of each Selector, to identify a minimum spanning set of additional questions to ask about subject business to accomplish a true/false resolution of each Selector. This set of questions is then presented to the business principal/operator performing business profiling, and the responses received are used to evaluate each Selector and produce a definition of the full set of applicable requirements on the business based upon the jurisdictions, business activities and other answers provided by the operator, which can then be presented to the operator.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. Functionality described herein also can be embodied in peripherals or add-in cards. Such functionality can also be implemented on a circuit board among different chips or processes executing in a single device, by way of further example.

For clarity of explanation, in some instances, the present technology can be presented as including individual functional blocks including functional blocks comprising devices, device components, steps or routines in a method embodied in software, or combinations of hardware and software.

Any steps, operations, functions, or processes described herein can be performed or implemented by a combination of hardware and software services or services, alone or in combination with other devices. In some embodiments, a service can be software that resides in the memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer-executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, universal serial bus (USB) devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Illustrative examples of the disclosure include:

Aspect 1. A method for determining regulatory requirements for a facility, the method comprising: transmitting a plurality of requests for display on a user device, the plurality of requests prompting the user for facility information; receive a selection in a first screen of a user interface of the user device, the selection including at least one jurisdiction of the user; generate a second screen for display on the user device, the second screen including a request for additional requirements, the request based on a jurisdiction received in the selection; receive a second selection in the second screen displayed on the user device, the second selection including an identification of a product selected by the user; and storing the first and second selection in a memory for transmission to an analytics device.

Aspect 2. The method of Aspect 1, further comprising: generating a third screen for display on the user device, the second screen including a request for additional requirements, the request based on a jurisdiction received in the selection; and receiving a third selection in the second screen displayed on the user device, the second selection including an identification of a product selected by the user.

Aspect 3. The method of any of Aspects 1 to 2, wherein the analytics device is configured to perform: filtering the first and second selection at the analytics device, wherein the filtering comprises: defining a plurality of selectors associated with at least one requirement of the jurisdiction; and identifying a correlation between the first and second selection and the at least one requirement of the jurisdiction.

Aspect 4. The method of any of Aspects 1 to 3, wherein the selectors define one or more of activities, licenses, and regulatory requirements associated with the jurisdiction.

Aspect 5. The method of any of Aspects 1 to 4, further comprising: filtering the defined selectors to identify a minimum amount of queries of a memory related to the correlation between the first and second selection.

Aspect 6. The method of any of Aspects 1 to 5, further comprising: determining additional selections are needed to identify a correlation; and automatically prompting the user via the user device with a plurality of additional requests for additional selections related to the jurisdiction selected.

Aspect 7. The method of any of Aspects 1 to 6, wherein the jurisdiction comprises one or more of a state, federal entity, or a country associated with a plurality of regulations.

Aspect 8. A system includes a storage (implemented in circuitry) configured to store instructions and a processor. The processor configured to execute the instructions and cause the processor to: transmit a plurality of requests for display on a user device, the plurality of requests prompting the user for facility information; receive a selection in a first screen of a user interface of the user device, the selection including at least one jurisdiction of the user; generate a second screen for display on the user device, the second screen including a request for additional requirements, the request based on a jurisdiction received in the selection; receive a second selection in the second screen displayed on the user device, the second selection including an identification of a product selected by the user; and store the first and second selection in a memory for transmission to an analytics device.

Aspect 9. The system of Aspect 8, wherein the processor is configured to execute the instructions and cause the processor to: generate a third screen for display on the user device, the second screen including a request for additional requirements, the request based on a jurisdiction received in the selection; and receive a third selection in the second screen displayed on the user device, the second selection including an identification of a product selected by the user.

Aspect 10. The system of any of Aspects 8 to 9, wherein the analytics device is configured to perform: filter the first and second selection at the analytics device, wherein the filtering comprises: define a plurality of selectors associated with at least one requirement of the jurisdiction; and identify a correlation between the first and second selection and the at least one requirement of the jurisdiction.

Aspect 11. The system of any of Aspects 8 to 10, wherein the selectors define one or more of activities, licenses, and regulatory requirements associated with the jurisdiction.

Aspect 12. The system of any of Aspects 8 to 11, wherein the processor is configured to execute the instructions and cause the processor to: filter the defined selectors to identify a minimum amount of queries of a memory related to the correlation between the first and second selection.

Aspect 13. The system of any of Aspects 8 to 12, wherein the processor is configured to execute the instructions and cause the processor to: determine additional selections are needed to identify a correlation; and evaluate a position of the reflection point with regard to the obstacle boundary.

Aspect 14. The system of any of Aspects 8 to 13, wherein the jurisdiction comprises one or more of a state, federal entity, or a country associated with a plurality of regulations.

Aspect 15. A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: transmit a plurality of requests for display on a user device, the plurality of requests prompting the user for facility information; receive a selection in a first screen of a user interface of the user device, the selection including at least one jurisdiction of the user; generate a second screen for display on the user device, the second screen including a request for additional requirements, the request based on a jurisdiction received in the selection; receive a second selection in the second screen displayed on the user device, the second selection including an identification of a product selected by the user; and store the first and second selection in a memory for transmission to an analytics device.

Aspect 16. The computer readable medium of Aspect 15, wherein the processor is configured to execute the computer readable medium and cause the processor to: generate a third screen for display on the user device, the second screen including a request for additional requirements, the request based on a jurisdiction received in the selection; and receive a third selection in the second screen displayed on the user device, the second selection including an identification of a product selected by the user.

Aspect 17. The computer readable medium of any of Aspects 15 to 16, wherein the analytics device is configured to perform: filter the first and second selection at the analytics device, wherein the filtering comprises: define a plurality of selectors associated with at least one requirement of the jurisdiction; and identify a correlation between the first and second selection and the at least one requirement of the jurisdiction.

Aspect 18. The computer readable medium of any of Aspects 15 to 17, wherein the selectors define one or more of activities, licenses, and regulatory requirements associated with the jurisdiction.

Aspect 19. The computer readable medium of any of Aspects 15 to 18, wherein the processor is configured to execute the computer readable medium and cause the processor to: filter the defined selectors to identify a minimum amount of queries of a memory related to the correlation between the first and second selection.

Aspect 20. The computer readable medium of any of Aspects 15 to 19, wherein the processor is configured to execute the computer readable medium and cause the processor to: determine additional selections are needed to identify a correlation; and evaluate a position of the reflection point with regard to the obstacle boundary.

Aspect 21. A system comprising: a storage configured to store instructions; a processor configured to execute the instructions and cause the processor to: determine a plurality of regulatory requirements for an entity comprising at least one or more of a questionnaire, a plurality of requirements, a plurality of jurisdictions, and one or more filters configured to determine an applicability of the plurality of regulatory requirements, the determining performed by steps comprising: identifying an answer to a plurality of questions in the questionnaire; receiving a selection of at least one jurisdiction in the plurality of jurisdictions; filtering the plurality of requirements based on a set of filter criteria to select one or more matching requirements; and storing the one or more matching requirements in a memory.

Aspect 22. The system of Aspect 21, wherein the filter criteria is a selector associated with each of the plurality of requirements.

Aspect 23. The system of any of Aspects 21 to 22, wherein the filter criteria is a logical expression that evaluates the applicability of the requirement.

Aspect 24. The system of any of Aspects 21 to 23, wherein the selector is implemented by evaluating a plurality of instructions associated with a computing device.

Aspect 25. The system of any of Aspects 21 to 24, wherein the memory is a persistent storage.

Aspect 26. The system of any of Aspects 21 to 25, wherein the persistent storage is a structured query language (SQL) database or a not only SQL (NoSQL) database.

Aspect 27. The system of any of Aspects 21 to 26, wherein the matching requirements are presented to an operator via an interface of a computing device.

Aspect 28. The system of any of Aspects 21 to 27, further comprising: generating a report based on the one or more matching requirements.

Aspect 29. The system of any of Aspects 21 to 28, wherein the report is one or more of an Adobe portable document format (PDF), hypertext markup language (HTML), Excel, or a CSV file.

Aspect 30. The system of any of Aspects 21 to 29, wherein an operator of a computing device presenting the plurality of questions interacts with the questionnaire to provide answers to each of the plurality of questions via a user interface of the computing device.

Aspect 31. The system of any of Aspects 21 to 30, wherein an operator selects a jurisdiction from the plurality of jurisdictions using a user interface of a computing device.

Aspect 32. The system of any of Aspects 21 to 31, wherein each of the matching requirements is represented in the memory a plurality of database records.

Aspect 33. The system of any of Aspects 21 to 32, wherein the database uses structured query language (SQL) to read and write to the plurality of database records.

Aspect 34. The system of any of Aspects 21 to 33, wherein the database uses not only SQL (NoSQL) formats included DynamoDB or MongoDB to read and write to the plurality of database records.

Aspect 35. The system of any of Aspects 21 to 34, wherein the filter criteria reference at least one of the plurality of questions to identify the one or more matching requirements.

Aspect 36. The system of any of Aspects 21 to 35, wherein the filter criteria reference at least one of the plurality of jurisdictions to identify the one or more matching requirements.

Aspect 37. The system of any of Aspects 21 to 36, wherein the plurality of jurisdictions includes one or more state, federal or country laws governing regulatory compliance.

Aspect 38. The system of any of Aspects 21 to 37, wherein the plurality of questions in the questionnaire entails information about the types of business a company conducts, details about its facilities, products and services which may be regulated.

Aspect 39. The system of any of Aspects 21 to 38, wherein the steps are initiated as a result of a user-initiated action.

Aspect 40. The system of any of Aspects 21 to 39, wherein the steps are automatically initiated based on one or more predefined triggers.

Aspect 41. The system of any of Aspects 21 to 40, wherein the steps are initiated upon a detection of a change in the plurality of regulatory requirements.

Aspect 42. The system of any of Aspects 21 to 41, wherein the steps are initiated due to a detection of a new set of requirements.

Aspect 43. The system of any of Aspects 21 to 42, wherein an operator is notified of a change that is detected in the plurality of regulatory requirement changes.

Aspect 44. The system of any of Aspects 21 to 43, wherein the operator is notified of the change via a user interface of a computing device.

Aspect 45. The system of any of Aspects 21 to 44, wherein the operator is notified via a message delivered asynchronously via email, an SMS message or an electronic messaging device or system.

Aspect 46. A system for determining regulatory requirements for a business, the system comprising a research activity processing module configured to perform the steps of: defining a set of selectors for a regulatory structure, each selector in the set of selectors comprising a data structure including a logical expression associated with a regulatory requirement, and a logical predicate indicating whether the regulatory requirement is applicable to a business; and gathering information on a business from a presentation of queries via a user interface that identifies a type of Business Activity in which the business is engaged, methods of manufacture, handling, or processing by a business of a product, and a type of business activity, wherein the business activity is based on the product ways in which product is made, handled or processed by the business, in one or more jurisdictions.

Aspect 47. The system of Aspect 46, further comprising a Filter processing module configured to perform the steps of: receiving a set of selectors chosen by the research activity processing module; filtering the set of selectors to identify a minimum necessary set of further queries relating to activities, licenses, additional events and documents of regulatory interest to resolve one or more logical predicates of each selector in the set of selectors; and presenting the set of further queries for display on a user interface of a computing device.

Aspect 48. The system of any of Aspects 46 to 47, further comprising: gathering a plurality of responses to the further queries; resolving the logical predicates of one or more chosen selectors based on the responses; and presenting filtered content of the selectors based on the logical predicate that resolves to true.

What is claimed is:

1. A method for determining regulatory requirements for a facility, the method comprising:
transmitting a plurality of requests for display on a user device, the plurality of requests prompting the user for facility information;
receive a selection in a first screen of a user interface of the user device, the selection including at least one jurisdiction of the user;
generate a second screen for display on the user device, the second screen including a request for additional requirements, the request based on a jurisdiction received in the selection;
receive a second selection in the second screen displayed on the user device, the second selection including an identification of a product selected by the user; and
storing the first and second selection in a memory for transmission to an analytics device.

2. The method of claim 1, further comprising:
generating a third screen for display on the user device, the second screen including a request for additional requirements, the request based on a jurisdiction received in the selection; and
receiving a third selection in the second screen displayed on the user device, the second selection including an identification of a product selected by the user.

3. The method of claim 1, wherein the analytics device is configured to perform:
filtering the first and second selection at the analytics device, wherein the filtering comprises:
defining a plurality of selectors associated with at least one requirement of the jurisdiction; and
identifying a correlation between the first and second selection and the at least one requirement of the jurisdiction.

4. The method of claim 3, wherein the selectors define one or more of activities, licenses, and regulatory requirements associated with the jurisdiction.

5. The method of claim 3, further comprising:
filtering the defined selectors to identify a minimum amount of queries of a memory related to the correlation between the first and second selection.

6. The method of claim 3, further comprising:
determining additional selections are needed to identify a correlation; and
automatically prompting the user via the user device with a plurality of additional requests for additional selections related to the jurisdiction selected.

7. The method of claim 1, wherein the jurisdiction comprises one or more of a state, federal entity, or a country associated with a plurality of regulations.

8. A system comprising:
a storage configured to store instructions;
a processor configured to execute the instructions and cause the processor to:
transmit a plurality of requests for display on a user device, the plurality of requests prompting the user for facility information;
receive a selection in a first screen of a user interface of the user device, the selection including at least one jurisdiction of the user;
generate a second screen for display on the user device, the second screen including a request for additional requirements, the request based on a jurisdiction received in the selection;
receive a second selection in the second screen displayed on the user device, the second selection including an identification of a product selected by the user; and
store the first and second selection in a memory for transmission to an analytics device.

9. The system of claim 8, wherein the processor is configured to execute the instructions and cause the processor to:
generate a third screen for display on the user device, the second screen including a request for additional requirements, the request based on a jurisdiction received in the selection; and
receive a third selection in the second screen displayed on the user device, the second selection including an identification of a product selected by the user.

10. The system of claim 8, wherein
the analytics device is configured to:
filter the first and second selection at the analytics device, wherein the filtering comprises:
defining a plurality of selectors associated with at least one requirement of the jurisdiction; and
identifying a correlation between the first and second selection and the at least one requirement of the jurisdiction.

11. The system of claim 10, wherein the selectors define one or more of activities, licenses, and regulatory requirements associated with the jurisdiction.

12. The system of claim 10, wherein the processor is configured to execute the instructions and cause the processor to:
filter the defined selectors to identify a minimum amount of queries of a memory related to the correlation between the first and second selection.

13. The system of claim 10, wherein the processor is configured to execute the instructions and cause the processor to:
determine additional selections are needed to identify a correlation; and
automatically prompt the user via the user device with a plurality of additional requests for additional selections related to the jurisdiction selected.

14. The system of claim 8, wherein the jurisdiction comprises one or more of a state, federal entity, or a country associated with a plurality of regulations.

15. A non-transitory computer readable medium comprising instructions, the instructions, when executed by a computing system, cause the computing system to:
transmit a plurality of requests for display on a user device, the plurality of requests prompting the user for facility information;
receive a selection in a first screen of a user interface of the user device, the selection including at least one jurisdiction of the user;
generate a second screen for display on the user device, the second screen including a request for additional requirements, the request based on a jurisdiction received in the selection;
receive a second selection in the second screen displayed on the user device, the second selection including an identification of a product selected by the user; and
store the first and second selection in a memory for transmission to an analytics device.

16. The non-transitory computer readable medium of claim 15, wherein the computer readable medium further comprises instructions that, when executed by the computing system, cause the computing system to:
generate a third screen for display on the user device, the second screen including a request for additional requirements, the request based on a jurisdiction received in the selection; and
receive a third selection in the second screen displayed on the user device, the second selection including an identification of a product selected by the user.

17. The computer readable medium of claim 15, wherein the analytics device is configured to:
filter the first and second selection at the analytics device, wherein the filtering comprises:
define a plurality of selectors associated with at least one requirement of the jurisdiction; and
identify a correlation between the first and second selection and the at least one requirement of the jurisdiction.

18. The computer readable medium of claim 17, the selectors define one or more of activities, licenses, and regulatory requirements associated with the jurisdiction.

19. The computer readable medium of claim 17, wherein the computer readable medium further comprises instructions that, when executed by the computing system, cause the computing system to:
filter the defined selectors to identify a minimum amount of queries of a memory related to the correlation between the first and second selection.

20. The computer readable medium of claim 17, wherein the computer readable medium further comprises instructions that, when executed by the computing system, cause the computing system to:
determine additional selections are needed to identify a correlation; and
evaluate a position of the reflection point with regard to the obstacle boundary.
